(19) United States
(12) Patent Application Publication
(10) Pub. No.: US 2015/0210949 A1
(43) Pub. Date: Jul. 30, 2015

(54) Methods and Systems for Combined Oxidative and Hydrotreatment of Hydrocarbon Fuel

(71) Applicant: Cetamax Ventures Ltd., Kowloon, Hong Kong (CN)

(72) Inventors: Roger Kai Lott, Edmonton (CA); Kamalul Arifin Yusof, Kajang Selangor (MY)

(73) Assignee: Cetamax Ventures Ltd., Kowloon, Hong Kong (CN)

(21) Appl. No.: 14/417,091

(22) PCT Filed: Jul. 23, 2013
(86) PCT No.: PCT/IB2013/002819

§ 371 Date: Jan. 23, 2015

Related U.S. Application Data
(60) Provisional application No. 61/677,855, filed on Jul. 31, 2012.

(51) Int. Cl. C10L 10/12; C10G 67/16; C11C 1/08; C10L 1/02; C11C 3/00; C10G 67/12; C10L 1/08

(52) U.S. Cl. CPC C10L 10/12; C10G 67/12; C10G 67/16; C10L 1/08; C10L 1/026; C11C 3/006; C11C 1/08; C10L 2200/0446; C10L 2200/0476; C10L 2270/026; C10L 2290/24

(57) ABSTRACT

A method for combined reductive and oxidative treatment of liquid hydrocarbon feedstock to form upgraded liquid fuel having increased cetane number and reduced sulfur content. The yield of upgraded liquid fuel having a given cetane number is higher than processes than only increase cetane number by oxidative treatment. The feedstock can be initially hydrotreated to reduce sulfur content followed by oxidative treatment to increase cetane number. A first portion of a hydrotreated intermediate stream can be oxidatively treated to yield high cetane number blending stock, which is combined with a second portion of the hydrotreated intermediate stream to yield upgraded liquid fuel having increased cetane number and reduced sulfur content. Combining hydrotreatment with oxidative treatment facilitated by high energy cavitation maximizes yield and fuel quality.

### BACKGROUND OF THE INVENTION

1. The Field of the Invention

The present invention is in the field of hydrocarbons and hydrocarbon fuels, more particularly in the field of processing hydrocarbons and hydrocarbon fuels, such as diesel and biodiesel, in order to increase the cetane number.

2. The Relevant Technology

Cetane number is a measurement of the combustion quality of diesel fuel during compression ignition. It is a significant expression of diesel fuel quality among a number of other measurements that determine overall diesel fuel quality. Cetane number is actually a measure of a fuel's ignition delay, which is the time period between the start of injection and start of combustion (ignition) of the fuel. For any given diesel engine, a higher cetane fuel will have a shorter ignition delay period than a lower cetane fuel.

Generally, diesel engines run well with a cetane number from 40 to 55. Fuels with higher cetane numbers and shorter ignition delays provide more time for the fuel combustion process to be completed. This, in turn, increases the extent and efficiency of combustion. Higher speed diesel engines operate more effectively when using higher cetane number fuels. Nevertheless, there is typically no performance or emission advantage when the cetane number is increased beyond approximately 55. Beyond this point, the fuel's performance hits a plateau.

By way of background, cetane is an un-branched, open chain, alkane molecule that ignites very easily under compression, so it was assigned a cetane number of 100. Conversely, alpha-methyl napthalene was assigned a cetane number of 0. All other hydrocarbons in diesel fuel are indexed to cetane as to how well they ignite under compression. The cetane number therefore measures how quickly the fuel starts to burn (auto-ignites) under diesel engine conditions (i.e., compression and temperature). Since there are hundreds of components in diesel fuel, with each having a different cetane quality, the overall cetane number of the diesel is the average cetane quality of all the components. There is typically very little actual cetane in diesel fuel.

In North America, most states adopt ASTM D975 as their diesel fuel standard, and the minimum cetane number is set at 40, with typical values in the 42-45 range. Premium diesel fuels may or may not have higher cetane numbers, which is supplier dependent. Premium diesel fuels often include additives to improve cetane number and lubricity, detergents to clean the fuel injectors and minimize carbon deposits, water dispersants, and other additives depending on geographical and seasonal needs.

In Europe, diesel cetane numbers were set at a minimum of 38 in 1994 and 40 in 2000. The current standard for diesel sold in Europe is determined by EN 590, with a minimum cetane index of 46 and a minimum cetane number of 51. Premium diesel fuel can have a cetane number as high as 60 in Europe.

Additives such as alkyl nitrates (e.g., 2-ethyl hexyl nitrate), di-tert-butyl peroxide, and dimethyl ether are commonly used as additives to raise the cetane number. Additives such as 2-ethyl hexyl nitrate are very expensive, costing approximately $2200/ton, and cannot be used in quantities greater than about 0.2% of the diesel fuel without becoming cost prohibitive.

Biodiesel from vegetable oil sources have been recorded as having a cetane number range of 46 to 52. Cetane numbers for animal-fat based biodiesels range from 56 to 60.

The cetane number of diesel fuel can also be increased by processing diesel fuel having a lower cetane number to yield a diesel fuel having a higher cetane number. For example, U.S. Pat. No. 5,114,434 to Praulus et al. describes a process by which viscoreduced diesel fuel is contacted with hydrogen peroxide in a reactor that includes a stirring mechanism. While the process disclosed by Praulus et al. effectively increased the cetane number, the amount of increase was modest (i.e., the cetane number was increased from 39 to 50 in one example and from 39 to 53.5 in another). Moreover, the residence time in the reactor was quite long, being 5 hours or more.

Another patent of possible interest is U.S. Pat. No. 6,500,219 to Gunnerman, which discloses a process for oxidative desulfurization of diesel fuel using ultrasound. The purpose of Gunnerman is to replace hydrodesulfurization, which Gunnerman disparages because hydrodesulfurization produces a considerable amount of unreacted H₂S gas, a health hazard, and hydrogen can leak through the reactor walls. Gunnerman operates by oxidizing sulfur-bearing organic molecules, making them water soluble, and then extracting the water-soluble sulfer-bearing molecules from the desulfurized organic hydrocarbon phase using water. Gunnerman operates at conditions selective to oxidation of sulfur-bearing compounds, with little or no oxidation of non-sulfur bearing molecules. For example, Gunnerman operates at high temperatures, preheating the diesel feed to at least about 70° C. and then operating the reactor at much higher temperatures generated by the reaction itself without cooling of the reactor.

### BRIEF SUMMARY OF THE INVENTION

It has now been unexpectedly found that a much higher yield of high quality, high cetane number liquid hydrocarbon fuel is made possible by the combined treatment of a liquid hydrocarbon fuel feedstock with two very different, and essentially opposite, processes: a reductive hydrotreatment process and an oxidative treatment process. By combining these two processes in series and/or in parallel, a synergistic benefit is obtained. The result is a liquid hydrocarbon fuel product having higher cetane number and/or higher overall yield of high cetane/low sulfur fuel product compared to fuels produced by each process individually.

According to one embodiment, a method for combined reductive and oxidative treatment of a liquid hydrocarbon feedstock to form an upgraded liquid fuel having increased cetane number and reduced sulfur content comprises: (1) providing a liquid hydrocarbon feedstock having an initial cetane number and an initial sulfur content; (2) reductively hydrotreating a first liquid feedstream selected from (a) at least a portion of the liquid hydrocarbon feedstock and (b) at least a portion of a partially upgraded feedstream formed by oxidative treatment of at least a portion of the liquid hydrocarbon feedstock; (3) oxidatively treating a second liquid feedstream selected from (a) at least a portion of the liquid hydrocarbon feedstock and (b) at least a portion of a partially upgraded feedstream formed by reductive hydrotreatment of at least a portion of the liquid hydrocarbon feedstock; and (4) collecting the upgraded liquid fuel produced by the combined reductive and oxidative treatment of the liquid hydrocarbon feedstock, the upgraded liquid fuel having a higher cetane number and a lower sulfur content than the liquid hydrocarbon feedstock.

According to another embodiment, all of the liquid hydrocarbon feedstock is initially hydrotreated to form a hydrotreated hydrocarbon intermediate with reduced sulfur content and optionally increased cetane number, followed by oxidatively treating at least a portion of the hydrotreated hydrocarbon intermediate to increase the cetane number. In one embodiment, all of the hydrotreated hydrocarbon intermediate is oxidatively treated to increase cetane number. In another embodiment, a first portion of the hydrotreated hydrocarbon intermediate is oxidatively treated to increase cetane number and form a high cetane number blending stock, which is thereafter blended with a second portion of the hydrotreated hydrocarbon intermediate to yield an upgraded liquid fuel.

According to yet another embodiment, all of the liquid hydrocarbon feedstock is initially oxidatively treated to form an oxidatively treated hydrocarbon intermediate with increased cetane number, followed by reductively hydrotreating at least a portion of the oxidatively treated hydrocarbon intermediate to reduce sulfur content and optionally further increase the cetane number. In one embodiment, all of the oxidatively treated hydrocarbon intermediate is hydrotreated to reduce sulfur content and optionally further increase the cetane number. In another embodiment, a first portion of the oxidatively treated hydrocarbon intermediate is hydrotreated to reduce sulfur content and optionally further increase cetane number and form a hydrotreated blending stock, which is thereafter blended with a second portion of the oxidatively treated hydrocarbon intermediate to yield an upgraded liquid fuel.

In an additional embodiment, the liquid hydrocarbon feedstock is initially divided into two feedstreams, a first of which is hydrotreated to yield a hydrotreated hydrocarbon intermediate and a second of which is oxidatively treated to yield an oxidatively treated hydrocarbon intermediate. The final upgraded liquid fuel can be formed by blending the hydrotreated hydrocarbon intermediate and oxidatively treated hydrocarbon intermediate together. Alternatively, the two different intermediate products can be used as different end products and/or used as blending stocks for blending with one or more additional fuel stocks to yield a final upgraded fuel product.

In general, the hydrotreating process utilizes a hydrotreating catalyst in a reactor (e.g., a fixed bed, ebullated bed, slurry bed, or moving bed) together with a liquid feedstock and hydrogen to yield a hydrotreated product. The hydrotreated product is characterized as having reduced sulfur and/or reduced metal and/or increased saturation of olefins and/or aromatic rings, which can increase cetane number. The hydrotreated product or intermediate can be separated from light gases, hydrogen, hydrogen sulfide, catalyst, and/or impurities using known methods.

In general, the oxidative treatment process utilizes an oxidative process in combination with ultrasonic cavitation, alone or in combination with stirring. According to one embodiment, the reaction is essentially a two-phase reaction including an oil phase and an aqueous phase. In another embodiment, it may be advantageous to introduce a third phase comprised of ozone gas. Ultrasonic mixing results in “cavitation” in which tiny micron size water bubbles are formed and collapse, which causes an intense release of energy. Cavitation can be performed in and/or upstream from the reactor used to oxidatively upgrade a liquid hydrocarbon stream. The result can be “super cetane diesel” with a cetane number substantially higher than 55, typically higher than about 75, and preferably higher than about 100, which can be used as a blending stock for fuels having lower cetane numbers in order to yield blended diesel fuels having a desired final cetane number.

The liquid hydrocarbon feedstock can have a boiling point in a range of about 150° C. to about 380° C. Exemplary liquid hydrocarbon feedstocks include one or more of refinery streams, straight petroleum runs, thermally cracked hydrocarbons, catalytically cracked hydrocarbons, hydrocracked hydrocarbons, biodiesels, vegetable oils, palm oil, and animal fats. Alternatively or in addition, the liquid hydrocarbon feedstock can be a material produced by visbreaking a material such as bright stock, used lubricating oil, or gas oil with a boiling point in a range of about 200° C. to about 500° C.

The oxidation source used to oxygenate the liquid hydrocarbon feedstock in the oxidative treatment process may be one or more of aqueous hydrogen peroxide, organic peroxide, inorganic peroxide, or ozone. The oxidation source generates hydroxyl radicals and/or oxygen radicals to oxygenate the liquid hydrocarbon feedstock. A catalyst that catalyzes the oxidation process can be used and may be iron, nickel, vanadium, and/or molybdenum, typically as a solid particulate or supported catalyst. An acid may be included to promote the oxidation reaction and may be an organic acid or an inorganic acid. Examples of organic acids are acetic acid, formic acid, oxalic acid, and/or benzoic acid. Examples of inorganic acids are sulfuric acid, nitric acid, and/or hydrochloric acid. The modified liquid hydrocarbon can be separated from light hydrocarbon gases, water, catalyst, and oxidation source by phase separation. The liquid fuel product separated from light hydrocarbon gases, water, catalyst and oxidation source can be further purified by extraction using a polar solvent, such as a lower alcohol (e.g., methanol), to remove over-oxidized materials.

In the case of feedstocks to be oxidatively treated that contain a relatively high sulfur content, it is generally desirable to minimize oxidation of sulfur-bearing molecules, which can form water-soluble sulfones that are lost in the aqueous phase. To ensure the oxidative treatment process is selective toward oxidation of hydrocarbons to increase cetane number while also minimizing oxidation of sulfur-bearing compounds (which can reduce yield by producing water-soluble byproducts), the process temperatures are controlled and generally lower (e.g., the feed temperature is maintained at a temperature less than about 65° C., preferably less than about 55° C., more preferably less than about 45° C., and most preferably less than about 35° C. (e.g., at about 30° C.), and the reactor is cooled to maintain the reaction temperature to less than 70° C., preferably less than about 65° C., more preferably less than about 60° C., and most preferably less than about 55° C. (e.g., at about 50° C.).

By using the inventive processes, the cetane number of a starting hydrocarbon feedstock can be increased by at least about 15%, preferably by at least about 20%, more preferably by at least about 30%, even more preferably by at least about 50%, and most preferably by at least about 75%. Such processes also result in an increase in cetane number of at least about 7.5, preferably at least about 10, more preferably at least about 15, even more preferably at least about 25, especially at least about 50, and most preferably at least about 75.

In addition, the sulfur content of the starting hydrocarbon feedstock can be decreased by at least about 30%, preferably by at least about 40%, more preferably by at least about 60%, even more preferably by at least about 75%, and most preferably by at least about 90%.

In many cases, the resulting product has a cetane number so high that it is best suited as a blending additive to raise the cetane number of a lower cetane number diesel fuel rather than as a diesel fuel by itself. According to one embodiment, the final blending stock can have a cetane number greater than about 60, preferably greater than about 75, more preferably greater than about 90, and most preferably greater than about 125.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 schematically illustrates an exemplary combined hydrotreatment and oxidative treatment system for producing an upgraded hydrocarbon product;

FIG. 2 is a flow diagram of an exemplary method for serial reductive hydrotreatment and oxidative treatment of a hydrocarbon feedstock to yield an upgraded hydrocarbon product;

FIG. 3 schematically illustrates an alternative exemplary combined hydrotreatment and oxidative treatment system for producing an upgraded hydrocarbon product;

FIG. 4 is a flow diagram of an exemplary reversed serial method for reductive hydrotreatment and oxidative treatment of a hydrocarbon feedstock to yield an upgraded hydrocarbon product;

FIG. 5 schematically illustrates another exemplary combined hydrotreatment and oxidative treatment system for producing an upgraded hydrocarbon product;

FIG. 6 is a flow diagram of an exemplary combined serial and parallel method for reductive hydrotreatment and oxidative treatment of a hydrocarbon feedstock to yield an upgraded hydrocarbon product;

FIG. 7 schematically illustrates another exemplary combined hydrotreatment and oxidative treatment system for producing an upgraded hydrocarbon product;

FIG. 8 is a flow diagram of an exemplary parallel method for reductive hydrotreatment and oxidative treatment of a hydrocarbon feedstock to yield an upgraded hydrocarbon product;

FIG. 9 schematically illustrates an exemplary oxidative treatment system for producing a high cetane number liquid fuel product from a liquid hydrocarbon stream;

FIG. 10 schematically illustrates another exemplary oxidative treatment system for producing a cetane number blending stock from a liquid hydrocarbon stream for upgrading a diesel product that otherwise fails to meet specification for cetane number.

FIG. 11 schematically illustrates an exemplary hydrotreatment system for removing sulfur and/or other impurities from a liquid hydrocarbon feedstock and optionally increasing cetane number;

FIG. 12 schematically illustrates another exemplary oxidative treatment system for increasing the cetane number of a liquid hydrocarbon stream;

FIG. 13 schematically illustrates an exemplary reactor that utilizes ultrasound to create cavitation and intimately mix a liquid hydrocarbon stream and oxidation source;

FIG. 14 is a flow diagram of an exemplary method for oxidatively increasing the cetane number of a liquid hydrocarbon stream;

FIG. 15 schematically illustrates an alternative exemplary oxidative treatment system for increasing the cetane number of a liquid hydrocarbon stream;

FIG. 16 is a flow diagram of an alternative exemplary method for oxidatively increasing the cetane number of a liquid hydrocarbon stream; and

FIG. 17 schematically illustrates an alternative exemplary oxidative treatment system for increasing the cetane number of a liquid hydrocarbon.

### DETAILED DESCRIPTION OF THE PREFERRED EMBODIMENTS

A detailed description of methods and systems for increasing cetane number and reducing sulfur content of a liquid hydrocarbon stream will now be provided with specific reference to the Figures illustrating preferred embodiments of the invention.

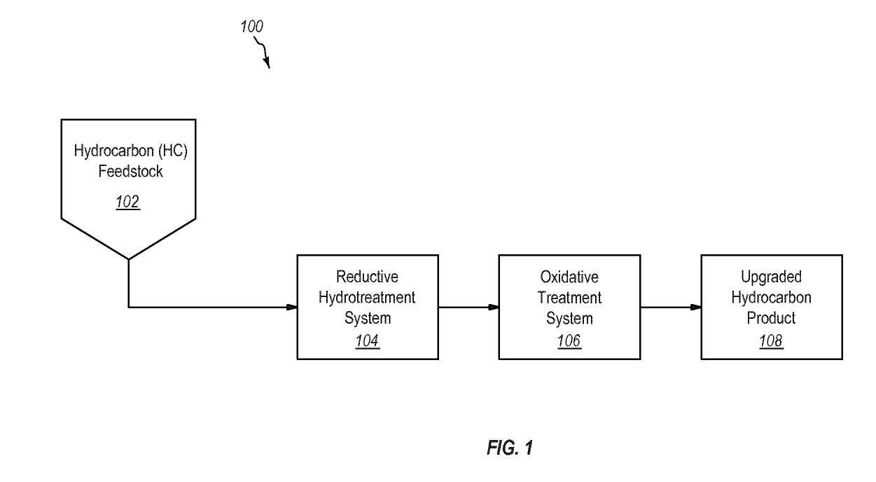

Reference is now made to FIG. 1, which schematically illustrates a combined reduction and oxidative system 100 for increasing cetane number and reducing sulfur content of a liquid hydrocarbon 102. The combined system 100 includes a hydrotreatment system 104 configured to reductively hydrotreat liquid hydrocarbon 102 to form a hydrotreated intermediate stream and an oxidative treatment system 106 configured to oxidatively treat at least a portion of the hydrotreated intermediate stream produced by or derived from the hydrotreatment system 104 to yield an upgraded hydrocarbon product 108 (e.g., an upgraded liquid fuel having increased cetane number and decreased sulfur content compared to the liquid hydrocarbon 102).

According to one embodiment, the liquid hydrocarbon feedstock 102 can have a boiling point, or boiling range, in a range of about 150° C. to about 380° C. The liquid hydrocarbon feedstock can have a cetane number less than 40, 35 or 30 and have a sulfur content in a range of about 50 to about 50,000 ppm. The liquid hydrocarbon feedstock may be a refinery stream (e.g., straight run, thermally cracked hydrocarbons, catalytically cracked hydrocarbons, or hydrocracked hydrocarbons) and/or produced by visbreaking a material such as bright stock, used lubricating oil, or gas oil with a boiling point in a range of about 200° C. to about 500° C. The liquid hydrocarbon feedstock may include or be derived from other materials, such as light catalytic cracking gas oil, light coker gas oil, light virgin gas oil, or kerosene. It will be appreciated that a wide variety of materials may be used for the liquid hydrocarbon feedstock so long as they yield a diesel fuel product having an increased cetane number.

A portion of the hydrocarbon feedstock may also comprise biodiesel, vegetable oil, or animal fat. Examples of vegetable oils include palm oil, colza oil, pine oil, soya oil, sunflower oil, maize oil, safflower oil, cottonseed oil, coriander oil, mustard oil, or tall oil. An example of animal fat is tallow oil. Examples of biodiesels include biodiesels created via chemical reaction of methanol with vegetable oil according to the following reaction:

Methanol+oil===>biodiesel fuel

The result is a fatty acid methyl ester having the formula CₘHₙO₂CH₃.

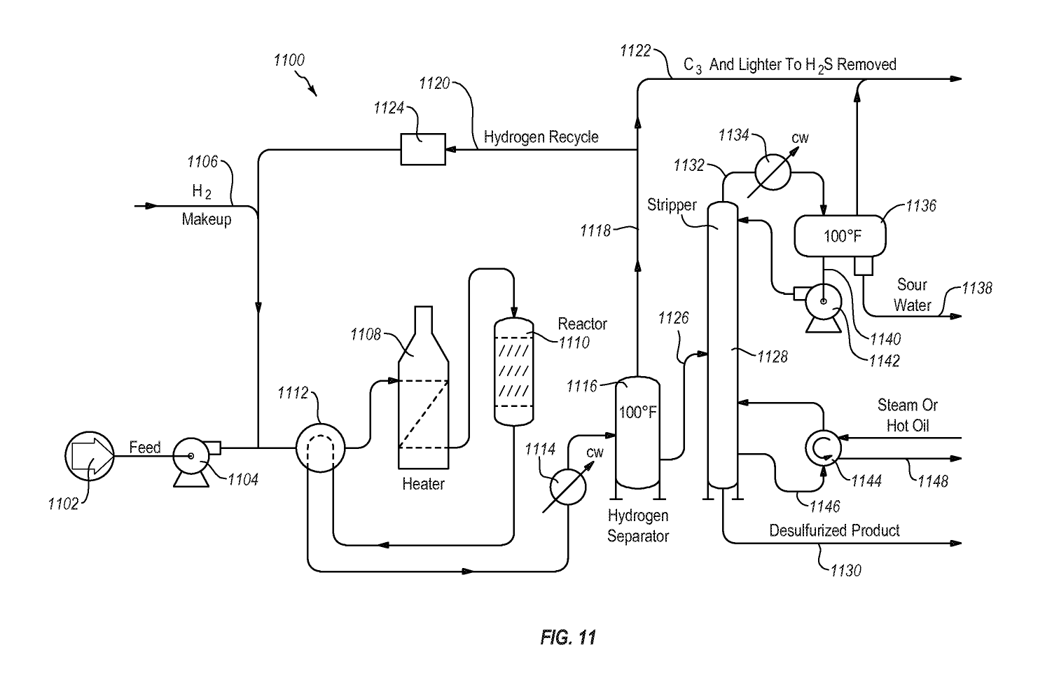

According to one embodiment, the hydrotreatment system 104 comprises known hydrotreatment apparatus and operates under known hydrotreatment conditions to yield a hydrotreated product with reduced sulfur content (e.g., a hydrotreatment system as illustrated in FIG. 11 and described below). Sulfur containing hydrocarbons are reduced through removal of hydrogen sulfide gas, which is removed as a byproduct.

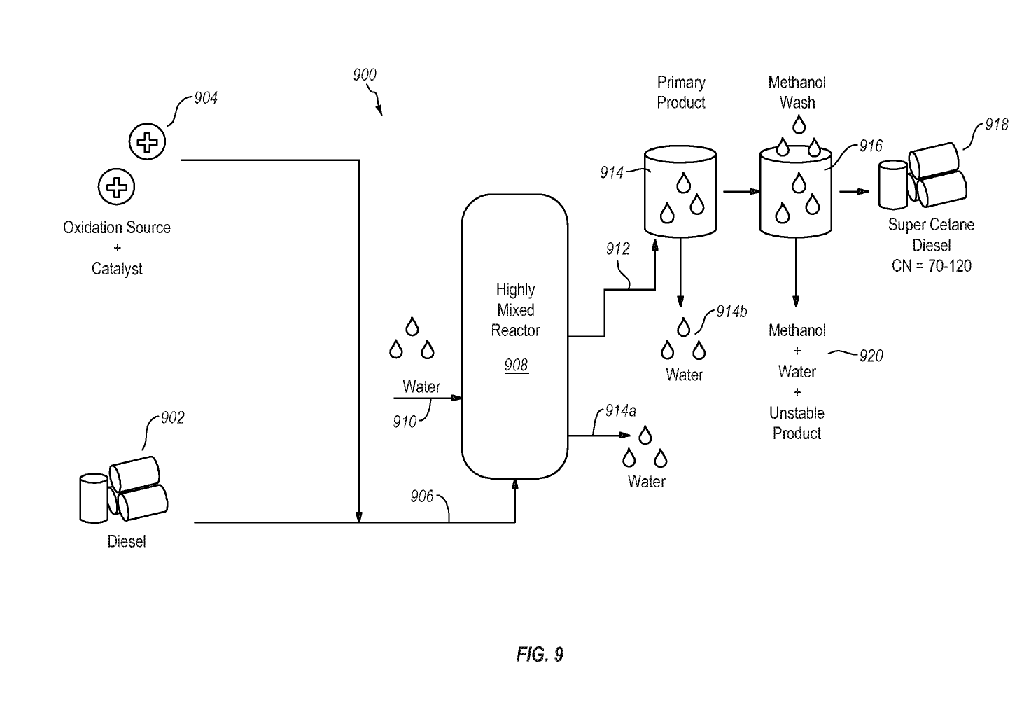

According to one embodiment, the oxidative treatment system 106 utilizes some or all of the apparatus illustrated in FIGS. 9-10, 12-13, 15 and/or 17 and described below. Additional details of useful oxidative treatment systems that can be used herein are disclosed in U.S. Published Application No. 2011/0065969, which is incorporated by reference.

Removing sulfur containing hydrocarbons prior to oxidative treatment as in combined system 100 reduces the number of such constituents that are thereafter subjected to oxidative treatment, which can increase the yield of high cetane fuel or blending stock and/or result in increased cetane number (e.g., by using more severe oxidation conditions than would otherwise be possible if the feedstock contained more sulfur containing hydrocarbons that would be otherwise converted to sulfones and caused to enter the aqueous phase and be removed from the hydrocarbon fraction). Combining hydrotreatment with oxidative treatment as in combined system 100 provides a synergistic benefit that cannot be realized using each process by itself to yield a final product, regardless of severity of reaction conditions.

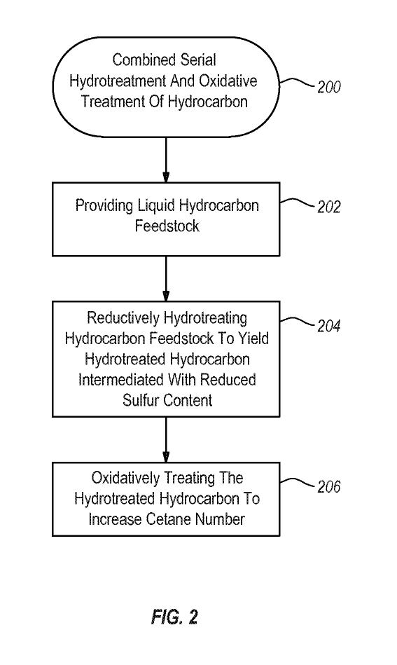

FIG. 2 is a flow chart that illustrates an exemplary combined method 200 for serially reductively hydrotreating and oxidatively treating a liquid hydrocarbon fuel in order to increase cetane number and reduce sulfur content and/or other impurities. A first step 202 includes providing a liquid hydrocarbon feedstock. The second step 204 involves reductively hydrotreating the liquid hydrocarbon feedstock to yield a hydrotreated hydrocarbon with reduce sulfur content. Hydrotreating 204 may also remove other impurities, such as nitrogen and metals. It may also hydrogenate olefins and/or aromatics contained in the liquid hydrocarbon feedstock, which can increase cetane number to some extent. A third step 206 involves oxidatively treating the hydrotreated hydrocarbon to raise cetane number. The resulting product may be further treated as desired and utilized as an upgraded fuel and/or as a blending stock mixed with diesel fuel of low cetane number to yield an upgraded diesel fuel having a desired cetane number.

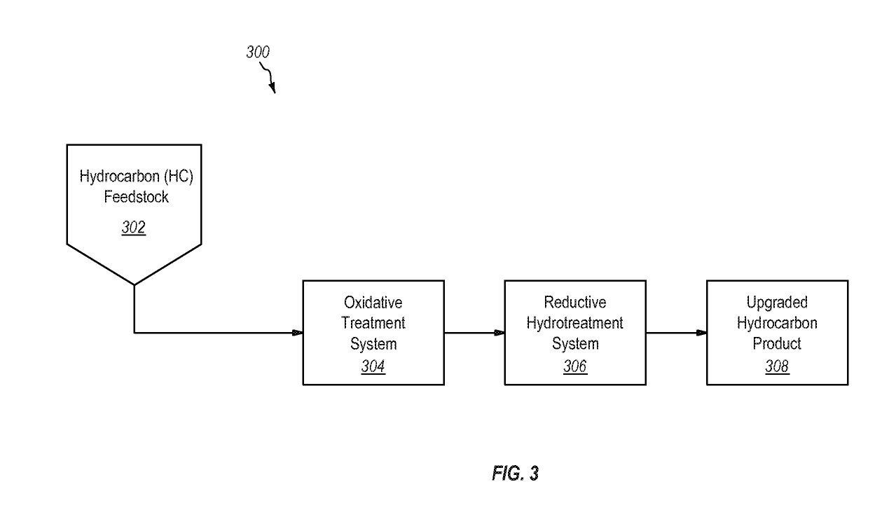

FIG. 3 schematically illustrates a combined reduction and oxidative system 300 for increasing cetane number and reducing sulfur content of a liquid hydrocarbon 302. The combined system 300 includes an oxidative treatment system 304 configured to oxidatively treat liquid hydrocarbon 302 to form an oxidatively treated intermediate stream and a hydrotreatment system 306 configured to reductively hydrotreat at least a portion of the oxidatively treated intermediate stream produced by or derived from the oxidative treatment system 304 to yield an upgraded hydrocarbon product 308 (e.g., an upgraded liquid fuel having increased cetane number and decreased sulfur content compared to the liquid hydrocarbon 302). In general, it may be advantageous to utilize the arrangement in this embodiment when the initial liquid hydrocarbon has a relatively low sulfur content to begin with to prevent formation of excessive quantities of sulfones, which can reduce overall yield by entering the aqueous phase and being removed from the hydrocarbon phase.

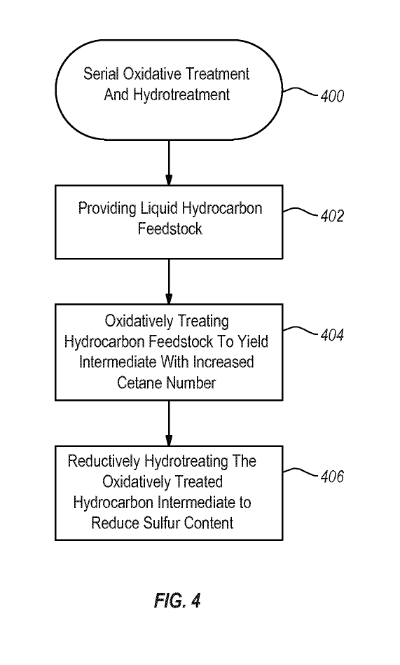

FIG. 4 is a flow chart that illustrates an exemplary combined method 400 for serially oxidatively treating and reductively hydrotreating a liquid hydrocarbon fuel in order to increase cetane number and reduce sulfur content and/or other impurities. A first step 402 includes providing a liquid hydrocarbon feedstock. The second step 404 involves oxidatively treating the liquid hydrocarbon feedstock to yield an oxidatively treated hydrocarbon with increased cetane number. A third step 406 involves reductively hydrotreating the oxidatively treated hydrocarbon to reduce sulfur content and/or remove other impurities, such as nitrogen and metals and/or hydrogenate olefins and/or aromatics contained in the liquid hydrocarbon feedstock, which can further increase cetane number. The resulting product may be further treated as desired and utilized as an upgraded fuel and/or as a blending stock mixed with diesel fuel of low cetane number to yield an upgraded diesel fuel having a desired cetane number.

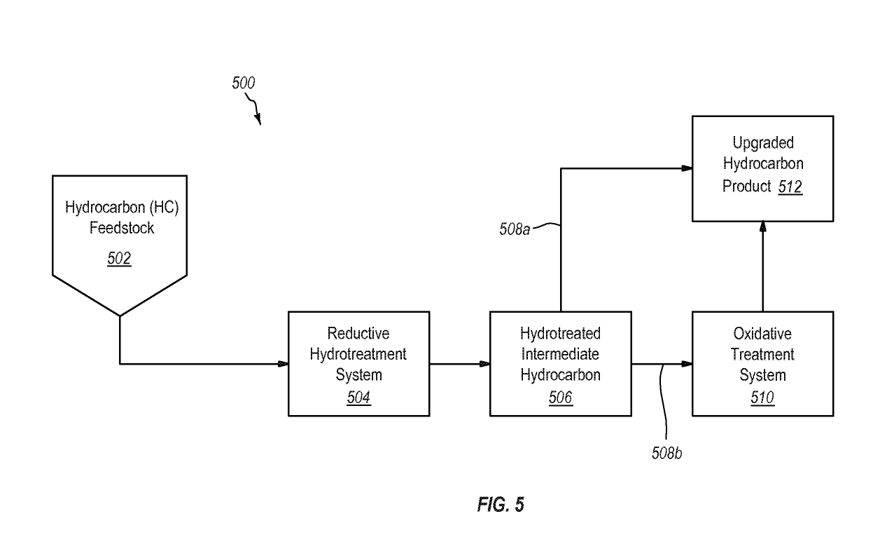

FIG. 5 schematically illustrates a combined reduction and oxidative system 500 for increasing cetane number and reducing sulfur content of a liquid hydrocarbon 502. The combined system 500 includes a hydrotreatment system 504 configured to reductively hydrotreat liquid hydrocarbon 502 to form a hydrotreated intermediate product 506, which is divided into a first hydrotreated intermediate stream 508a and a second hydrotreated intermediate stream 508b. The combined system 500 further includes an oxidative treatment system 510 that is configured to oxidatively treat the second hydrotreated intermediate stream 508b to yield a blending stock, which is then combined with the first hydrotreated intermediate stream 508a to yield a combined upgraded hydrocarbon product 512 (e.g., an upgraded liquid fuel having increased cetane number and decreased sulfur content compared to the liquid hydrocarbon 502). The oxidative treatment system 510 advantageously produces a blending stock having very high cetane number (e.g., higher than is required for the final upgraded liquid fuel 512) because it is used as a blending stock. This increases the value and justifies the cost of producing a material with a higher cetane number than is required for the upgraded fuel 512. In addition, oxidatively treating an intermediate hydrocarbon than has already been hydrotreated to remove most of the sulfur permits harsher oxidation conditions than would otherwise be permissible using a higher sulfur content hydrocarbon feed (e.g., because oxidizing sulfur-containing moieties may reduce yield by producing a water-soluble or hydrophilic product that is removed with the oxidation mixture and/or hydrophilic byproducts with the methanol wash).

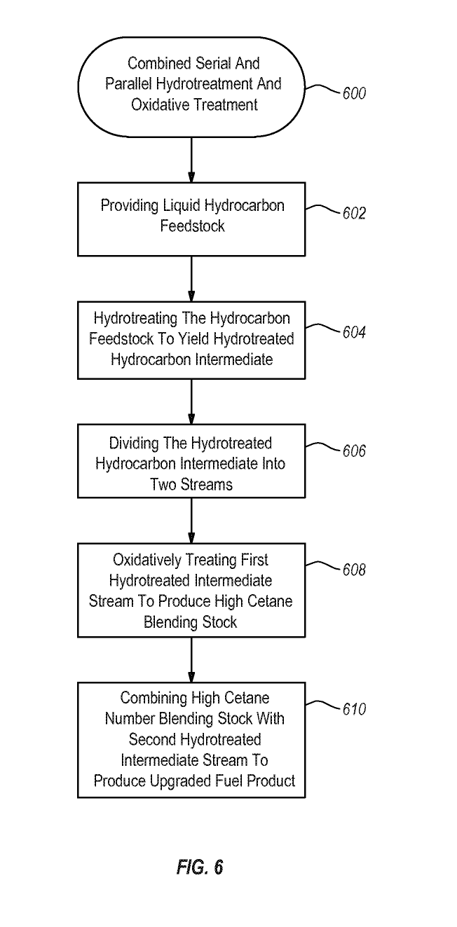

FIG. 6 is a flow chart that illustrates an exemplary combined method 600 for oxidatively treating and reductively hydrotreating a liquid hydrocarbon fuel serially and in parallel in order to increase cetane number and reduce sulfur content and/or other impurities. A first step 602 includes providing a liquid hydrocarbon feedstock. The second step 604 involves reductively hydrotreating the liquid hydrocarbon feedstock to yield a hydrotreated hydrocarbon intermediate with reduced sulfur content and optionally increased cetane number. A third step 606 involves dividing the hydrotreated hydrocarbon intermediate into two streams. A fourth step 608 includes oxidatively treating the first hydrotreated intermediate stream to produce a high cetane number blending stock. A fifth step 610 includes combining the high cetane number blending stock with the second hydrotreated intermediate stream to yield an upgraded liquid fuel (e.g., with higher cetane number and lower sulfur than the liquid hydrocarbon feedstock).

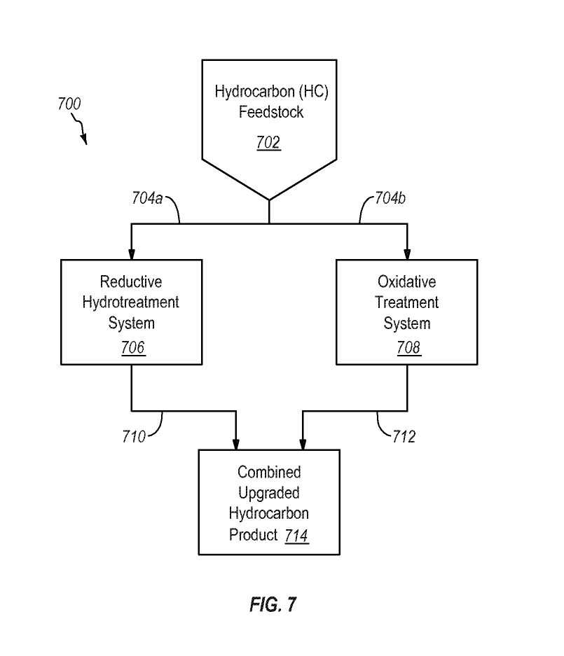

FIG. 7 schematically illustrates a combined reduction and oxidative system 700 for increasing cetane number and reducing sulfur content of a liquid hydrocarbon feedstock 702. The combined system 700 includes at least one valve and multiple conduits for dividing the liquid hydrocarbon feedstock 702 into a first liquid hydrocarbon feedstream 704a and a second liquid hydrocarbon feedstream 704b. The combined system 700 further comprises a reductive hydrotreatment system 706 configured to reductively hydrotreat first liquid hydrocarbon feedstream 704a to form a hydrotreated product 710 having reduced sulfur content and optionally higher cetane number and an oxidative treatment system 708 configured to oxidatively treat second liquid hydrocarbon feedstream 704b to form an oxidatively treated product 712 having higher cetane number. The hydrotreated product 710 and the oxidatively treated product 712 are combined to form a combined upgraded hydrocarbon product 714 (e.g., an upgraded liquid fuel having increased cetane number and decreased sulfur content compared to the liquid hydrocarbon 702).

According to one embodiment, the oxidative treatment system 708 is added to an existing hydrotreatment system 706 in order to increase both the yield and quality of the final product 714 compared to the hydrotreated product 710 by itself. To the extent the oxidative treatment system 708 is less expensive than adding a new hydrotreatment system and/or increasing the capacity of hydrotreatment system 706, adding the oxidative treatment system 708 to an existing hydrotreatment system provides the added benefit of decreased capital expenditure required to improve yield and/or quality.

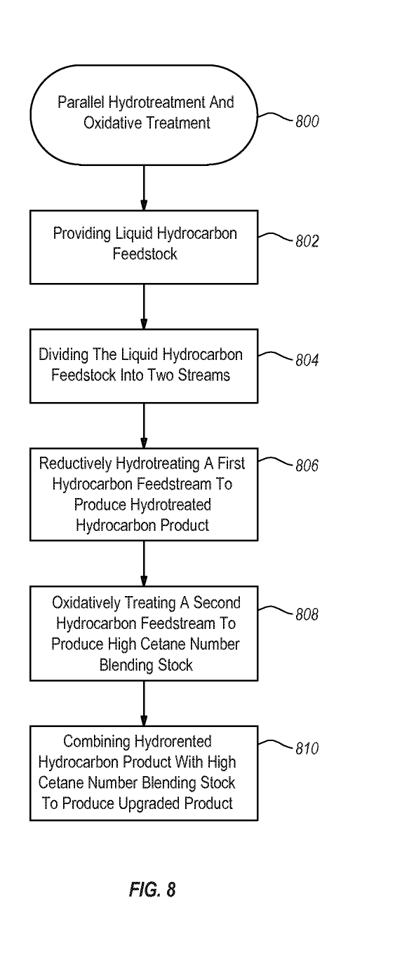

FIG. 8 is a flow chart that illustrates an exemplary combined method 800 for oxidatively treating and reductively hydrotreating a liquid hydrocarbon fuel in parallel in order to increase cetane number and reduce sulfur content and/or other impurities. A first step 802 includes providing a liquid hydrocarbon feedstock. The second step 804 involves dividing the liquid hydrocarbon feedstock into two streams. The third step 806 involves reductively hydrotreating a first liquid hydrocarbon feedstream to yield a hydrotreated hydrocarbon produce with reduced sulfur content and optionally increased cetane number. A fourth step 808 includes oxidatively treating a second liquid hydrocarbon feedstream to produce a high cetane number blending stock. A fifth step 810 includes combining the high cetane number blending stock produced in fourth step 808 with the hydrotreated product produced in third step 806 to yield an upgraded liquid fuel (e.g., with higher cetane number and lower sulfur than the liquid hydrocarbon feedstock). Alternatively, at least a portion of the high cetane number blending stock produced in fourth step 808 can be combined with the liquid hydrocarbon feedstock and/or other liquid fuel to increase the cetane number of such material.

FIG. 9 schematically illustrates an oxidative system 900 for increasing the cetane number of a liquid diesel fuel 902. The oxidative system 900 includes conduits and/or mixing apparatus for combining the liquid diesel fuel 902 with an oxidation source and catalyst 904 to yield a feedstream 906 that is fed into highly mixed oxidative reactor 908 together with water 910. Separate channels permit removal of an upgraded hydrocarbon intermediate 912 and water 914a from the oxidative reactor 908. A separator 914 receives the upgraded hydrocarbon intermediate 912 and removes additional water 914b. A methanol wash vessel 906 receives the further upgraded material from the separator 914, which removes the upgraded high cetane number diesel fuel 918 from an extraction phase 920 comprised of methanol, water and unstable (e.g., hydrophilic) product.

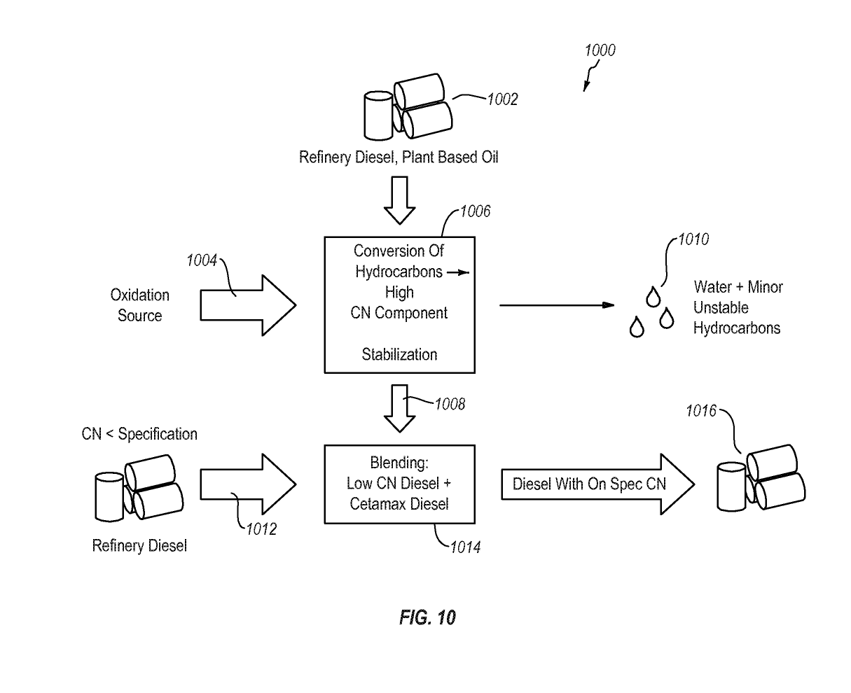

FIG. 10 schematically illustrates another oxidative system 1000 for increasing the cetane number of a refinery diesel fuel and/or plant based oil feedstream 1002. The oxidative system 1000 includes an oxidative reactor/separation system 1006 that processes feedstream 1002 using an oxidation source 1004 to yield an upgraded blending stock 1008, which is separated from water and minor unstable hydrocarbons 1010. The blending stock 1008 can be mixed with a refinery diesel product 1012 having a cetane number below specification in a blending vessel 1014 to yield an upgraded diesel fuel 1016 having a cetane number that meets specification.

FIG. 11 schematically illustrates an exemplary hydrotreating system 1100 for reductively hydrotreating a hydrocarbon feedstream 1102. A pump 1104 is used to pressurize the hydrocarbon feedstream 1102, and a conduit mixes the pressurized hydrocarbon feedstream 1102 with hydrogen gas, including makeup hydrogen gas 1106. A heater 1108 preheats the pressurized hydrocarbon feedstream 1102 and hydrogen gas, which are fed into a reactor 1110, which can be a fixed bed reactor but may alternatively be an ebullated bed, slurry bed, or moving bed reactor. The reactor 1110 includes a hydrotreating catalyst as is known in the hydrotreating art, such as, for example, molybdenum, cobalt, vanadium, tungsten, nickel and/or iron. The reaction temperature and pressure are suitable for hydrotreating rather than hydrocracking in order to maintain the same or similar boiling range, while removing sulfur, nitrogen, metals, and other impurities, while saturating olefins and/or hydrogenating aromatic rings.

The hydrotreated product 1112 from the reactor 1110 can be fed into a heat exchanger 1113 to help preheat the feedstream 1102 and remove excess heat from the hydrotreated product 1112. A valve 1114 reduces the pressure of the hydrotreated product 1112, which is fed into a hydrogen separator 1116 to remove volatiles 1118 from liquid product 1126. The volatiles 1118 are further separated using known apparatus into a hydrogen recycle stream 1120, which is repressurized by pump 1124 and mixed with makeup hydrogen 1106, and waste stream 1122 containing light hydrocarbons (e.g., C₃ hydrocarbons and lighter) and hydrogen sulfide gas.

The liquid product 1126 from the hydrogen separator 1116 is fed into a stripper 1128 to separate a desulfurized hydrocarbon product 1130 from additional volatiles 1132, which are passed through a pressure reduction valve 1134 and into an aqueous wash vessel 1136, which removes sour water 1138 from light hydrocarbons, which are combined with stream 1122, and a recycled product 1140, which is repressurized using pump 1142 and recycled back to stripper 1128 for further processing. A side stream 1146 is fed into a heat exchanger 1144 to obtain additional heat from steam or hot oil 1148 and then fed back into stripper 1128. The desulfurized product 1130 can be further treated as desired, such as fed into an oxidative reactor (not shown) to increase cetane number and/or blended with a high cetane number blending stock from an oxidative reactor according to any of the methods and systems disclosed herein.

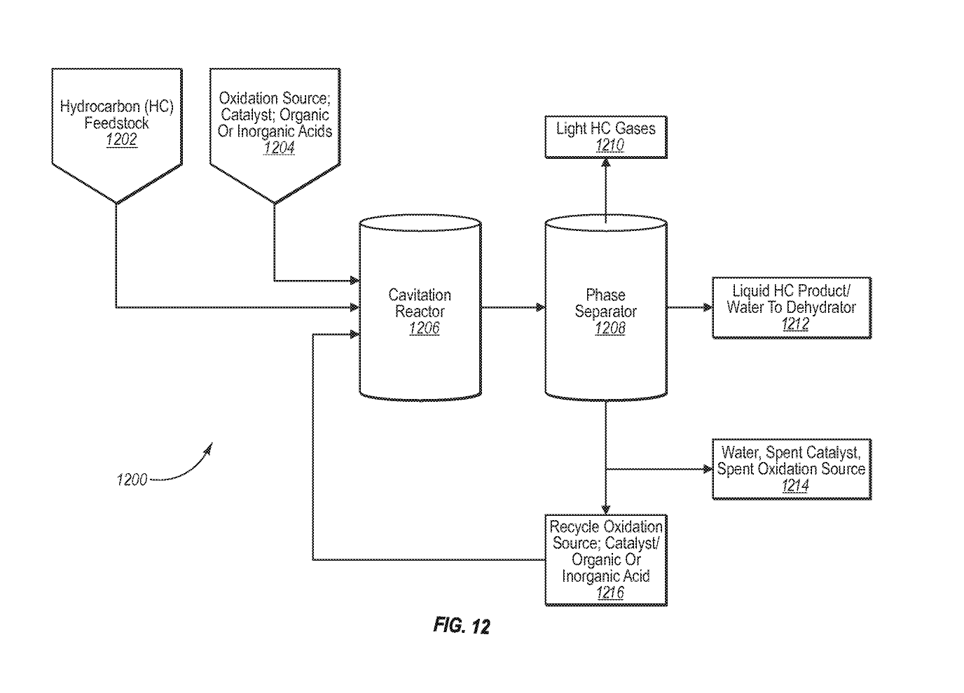

FIG. 12 schematically illustrates an exemplary oxidative treatment system 1200 for increasing the cetane number of a liquid hydrocarbon. A liquid hydrocarbon (HC) feedstock 1202 is fed into a cavitation reactor 1206 together with additional reactants 1204, which can include an oxidation source, catalyst, and organic or inorganic acid. Although FIG. 12 depicts a single cavitation reactor 1206, will be appreciated that a series of rectors can be utilized, including multiple cavitation reactors or a cavitation reactor and one or more oxidative reactors that include a conventional stirring mechanism. According to one embodiment, the liquid hydrocarbon feedstock may have a sulfur content in a range of about 10 to about 5000 ppm, optionally reduced by upstream hydrotreating. Removing sulfur before oxidative treatment is beneficial as oxidation of sulfur-containing hydrocarbons can transform them into oxygenated compounds that are more water rather than oil soluble, thereby reducing the yield of the high cetane product.

Examples of an “oxidation source” as used herein is a peroxide material, which is typically a compound of the molecular structure:

R₁—O—O—R₂

wherein, R₁ and R₂ are singly or collectively a hydrogen atom, an organic group, or an inorganic group. Examples of peroxides in which R₁ is an organic group and R₂ is a hydrogen include water-soluble peroxides such as methyl hydroperoxide (i.e., peroxy formic acid), ethyl hydroperoxide (i.e., peroxy acetic acid), isopropyl hydroperoxide, n-butyl hydroperoxide, sec-butyl hydroperoxide, tert-butyl hydroperoxide, 2-methoxy-2-propyl hydroperoxide, tert-amyl hydroperoxide, and cyclohexyl hydroperoxide. Examples of peroxides in which R₁ is an inorganic group and R₂ is a hydrogen include peroxonitrous acid, peroxophosphoric acid, and peroxosulfuric acid. A preferred peroxide is hydrogen peroxide (i.e., in which both of R₁ and R₂ are hydrogen atoms). A wide variety of different peroxides or other oxidation sources can be utilized so long as they assist in oxygenating the liquid hydrocarbon feedstock and result in a diesel fuel product having increased cetane number. Ozone can function as the oxidation source but is best suited for pretreating an aqueous mixture comprising water and acid (FIGS. 4 and 5) rather than mixing directly with a liquid hydrocarbon feedstock, as that can form an explosive mixture.

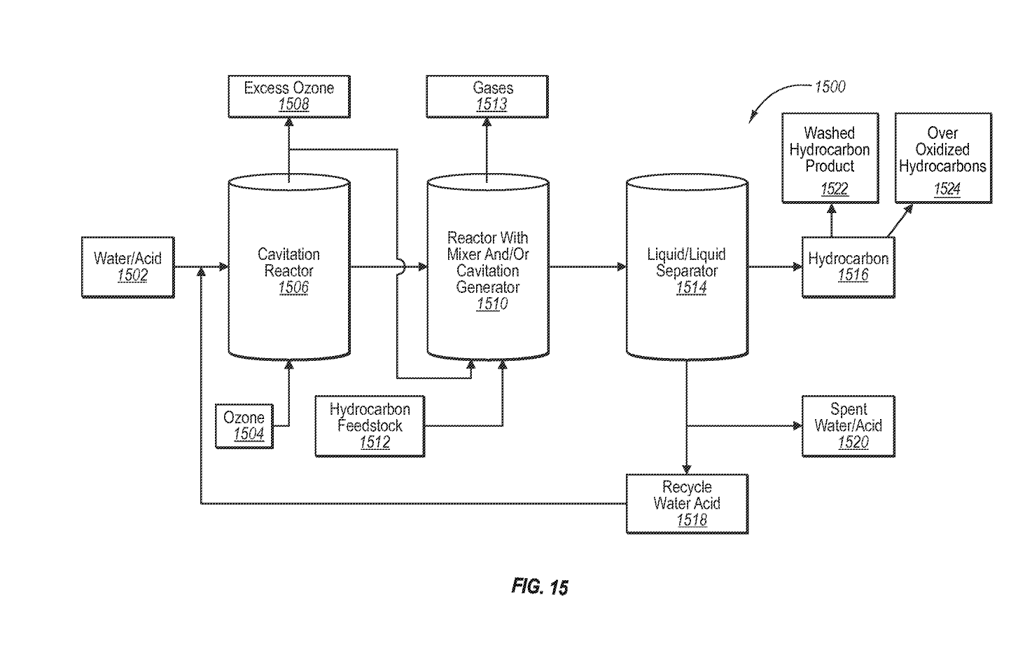

According to one embodiment, the amount of peroxide or other oxidation source used per kilogram of liquid hydrocarbon feedstock may be less than 300 g, though typically it is at least about 10 g and may range from about 25 g to 300 g hydrogen peroxide per kilogram of liquid hydrocarbon feedstock. The hydrogen peroxide may be employed in the form of an aqueous solution containing, for example, and most typically, from approximately 10% to 70% by weight of hydrogen peroxide. If a different peroxide is used in the absence of hydrogen peroxide, it is typically employed in the same molar quantities as hydrogen peroxide. If a different peroxide is used in combination with hydrogen peroxide, the cumulative molar ratio of such other peroxide and hydrogen peroxide can be the same as that of hydrogen peroxide used by itself. If ozone is used in combination with hydrogen peroxide, the concentration of hydrogen peroxide may be less than 50%. Generally, it is not recommended to use ozone alone as the oxidation source because the combination of hydrocarbon and ozone can create an explosive environment in the process. If ozone is utilized in the cavitation reactor 1206, the reactor is advantageously equipped with a conduit or other means for venting excess ozone through the top of the cavitation reactor 1206 (See FIG. 15, elements 1508, 1513).

The acid utilized may be an organic carboxylic acid, for example an acid selected from among formic acid, acetic acid, or propionic acid. Alternatively, or in addition, the acid may be an inorganic acid, for example an acid selected from sulfuric acid, nitric acid, or hydrochloric acid. Formic acid is a preferred organic acid. Sulfuric acid is a preferred inorganic acid. The molar ratio of acid/hydrogen peroxide preferably ranges from about 0.01 to about 1, and even more preferably from about 0.1 to about 0.5.

The catalyst may be any catalyst that can promote the oxidation of the liquid hydrocarbon feedstock in the presence of the oxidation source and acid. Examples of suitable catalyst metals include, but are not limited to, iron, nickel, vanadium and molybdenum. The catalysts may be in the form of solid particulates, either alone or on an appropriate support material (e.g., silica or alumina). Alternatively, the catalysts may be in the form of fine particulates, such as ferric oxide.

The liquid hydrocarbon feedstock 1202 can comprise the oil phase entering the cavitation reactor 1206, and the oxidation source, catalyst and organic or inorganic acid can comprise an aqueous phase entering the cavitation reactor 1206. The catalyst may also form a separate solid phase before or during the reaction. The cavitation reactor 1206 can be any reactor able to create cavitation with intimate, high energy mixing of the oil phase and oxidation source in the aqueous phase within the reactor. According to one embodiment, the cavitation reactor 1206 is an ultrasonic cavitation reactor that generates acoustic cavitation. According to another embodiment, the cavitation reactor 1206 includes a spinning rotor capable of creating mechanical cavitation. According to yet another embodiment, the cavitation reactor 1206 is configured to generate cavitation by means of an oscillating magnetic field. Cavitation can alternatively be created by hydrodynamic flow of the liquid reactants. In other embodiments, the cavitation reactor 1206 can employ optic cavitation (e.g., by laser pulses) or particle cavitation (e.g., by proton or neutrino pulses).

Depending on the sulfur content of the feedstock, the operating temperature of the cavitation reactor 1206 can be in a range of about 20° C. to about 200° C., preferably in a range of about 25° C. to about 150° C., more preferably in a range of about 30° C. to about 100° C., and most preferably in a range of about 40° C. to about 80° C. In order to control the temperature inside the cavitation reactor 1206, it may be desirable to utilize cooling means known in the art, such as, by way of example, one or more cooling or heat exchange coils (e.g., utilizing liquid water) (not shown) positioned within the reactor.

In the case of feedstocks that contain a relatively high sulfur content (e.g., which have not been subject to hydrotreatment or hydrodesulfurization), it is beneficial to minimize the oxidation of sulfur-bearing molecules, which can form water-soluble sulfones. To provide an oxidative treatment process that is selective toward oxidation of hydrocarbons while minimizing oxidation of sulfur-bearing compounds (which can greatly reduce yield by producing water-soluble byproducts), the temperatures of the process are kept sufficiently low. One way to control the reaction temperature is by keeping the temperature of the feed low as it is introduced into the reactor. For example, the feed temperature can be maintained at a temperature of less than 68° C., preferably less than about 65° C., more preferably less than about 60° C., even more preferably less than about 55° C., more especially preferably less than about 50° C. and most preferably less than about 45° C., 40° C., or 35° C., (e.g., the feed can be about 30° C.). Alternatively, or in addition to controlling the feed temperature, the reactor can be cooled to maintain the reaction temperature at less than 80° C., preferably less than 75° C., more preferably less than about 70° C., even more preferably less than about 65° C., more especially preferably less than about 60° C., and most preferably less than about 55° C. (e.g., the reactor temperature can be about 50° C.).

The operating pressure of the cavitation reactor 1206 can be in a range of about 1 bar to about 30 bars, preferably in a range of about 2 bars to about 27.5 bars, more preferably in a range of about 3 bars to about 25 bars, and most preferably in a range of about 5 bars to about 20 bars.

The reactants are maintained within the cavitation reactor 1206 for a time sufficient to carry out a desired oxygenation reaction and raise the cetane number of the liquid hydrocarbon product relative to the liquid hydrocarbon feedstock 1202. The reaction time is typically in a range of about 0.5 minute to about 90 minutes, preferably in a range of about 5 minutes to about 60 minutes, and more preferably in a range of about 8 minutes to about 40 minutes.

In general, it will be desirable to control the temperature, pressure and reaction time in order to promote beneficial oxygenation reactions while substantially preventing detrimental oxygenation reactions. For example, beneficial oxygenation reactions include oxygenating week H—C bonds of aromatic and hydroaromatic compounds, particularly at the benzylic position. Such oxygenation reactions increase the cetane number of the diesel. Examples of detrimental oxygenation reactions that decrease the cetane number of the diesel include oxidation of strong primary, secondary and tertiary alkyl H—C bonds found in paraffins and cycloparaffins, or oxidation of aromatics at non-benzylic positions, such as in the ring, to form phenol. In order to promote thermal and storage stability, it may be advantageous to keep the oxygenate level between about 0.5% to about 1%.

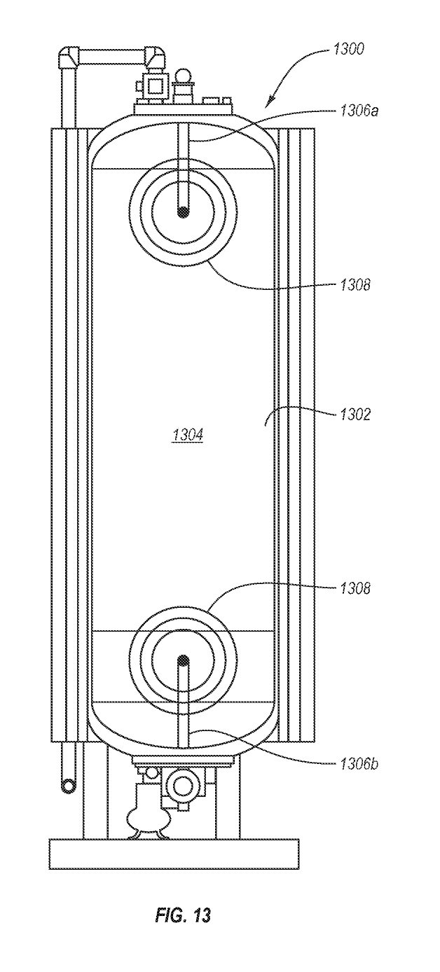

An exemplary embodiment of an ultrasonic reactor 1206 useful in the oxidation system 1200 of FIG. 12 is illustrated in FIG. 13. Reactor 1300 shown in FIG. 13 includes a reactor vessel 1302 containing reactants 1304. The reactants include an oil phase and an aqueous phase, and possibly also a gaseous phase, as described herein. A first ultrasonic emitter 1306a is positioned at the top end of reactor vessel 1302, and a second ultrasonic emitter 1306b is positioned at the bottom end of reactor vessel 1302. The ultrasonic emitters 1306 produce ultrasonic waves 1308, which propagate throughout the entire volume of reactor vessel 1302. The ultrasonic waves 1308 and waves created by cavitation cause intimate, high energy mixing of the oil and aqueous reactants 1304 within the reactor vessel 1302.

In general, ultrasonic energy in accordance with the reaction vessel 1302 is applied by the use of ultrasonics, which are sound-like waves whose frequency is above the range of normal human hearing, i.e., above 20 kHz (20,000 cycles per second). Ultrasonic energy with frequencies as high as 10 gigahertz (10,000,000,000 cycles per second) has been generated, but for purposes of this invention, useful results will be achieved with frequencies in a range of about 20 kHz to about 200 kHz, and preferably in a range of about 20 kHz to about 50 kHz. Ultrasonic waves can be generated from mechanical, electrical, electromagnetic, or thermal energy sources. The intensity of the sonic energy may also vary widely. For the purposes of this invention, desired results will generally be achieved with an intensity ranging from about 30 watts/cm² to about 300 watts/cm², or preferably from about 50 watts/cm² to about 100 watts/cm². One exemplary electromagnetic source can be a magnetostrictive transducer, which converts magnetic energy into ultrasonic energy by applying a strong alternating magnetic field to certain metals, alloys or ferrites. The typical electrical source is a piezoelectric transducer, which uses natural or synthetic single crystals (such as quartz) or ceramics (such a barium titanate or lead zirconate) and applies an alternating electrical voltage across opposite faces of the crystal or ceramic to cause an alternating expansion and contraction of crystal or ceramic at the impressed frequency. The various methods of producing and applying ultrasonic energy, and commercial suppliers of ultrasound equipment, are well known among those skilled in the use of ultrasound.

One exemplary ultrasonic reactor is available from Hielscher Ultrasonics GmbH, which is located in Teltow, Germany. According to the product literature relating to this product, the exposure of liquids to ultrasonic waves of high intensity causes acoustic cavitation. “Acoustic cavitation” (and other forms of “cavitation”) is the formation and subsequent violent collapse of small vacuum (cavitation) bubbles. Locally, extreme conditions arise from the violent collapse of each bubble. Localized temperatures can be as high as 5000 Kelvin. Localized pressures can be up to 2000 atmospheres. Liquid jets can form at up to 1000 km/hr. Such conditions promote a better surface chemistry of catalysts by enhancing micro-mixing. In particular, the high local temperature changes the chemical reaction kinetics of the oxidation process.

Returning to FIG. 12, after the liquid hydrocarbon has been converted into a liquid hydrocarbon product of higher cetane number (e.g., diesel fuel additive), the reactants are transferred from the cavitation reactor 1206 into a phase separator 1208. The phase separator 1208 causes or permits different fractions to separate into phases, thereby effecting their separation. Light hydrocarbon gases 1210 are removed from the top because they are volatile and in gaseous form rather than liquid. The main liquid hydrocarbon product 1212 is removed by phase separation from the main aqueous phase. The liquid hydrocarbon product 1212 will contain both liquid hydrocarbon product and residual water, which is removed using a dehydrator known to those of skill in the art. Dehydration can be effected using heat and/or chemical extraction. The main aqueous phase can be further divided using known means into a first fraction 1214 comprised of water, spent catalyst, and spent oxidation source and a second fraction 1216 comprised of recycle oxidation source, recycle catalyst, and recycle organic or inorganic acid. The second fraction 1216 comprised of recycle materials can be returned to the ultrasonic reactor 1206.

The dehydrated liquid hydrocarbon product can be further purified by extracting over-oxidated hydrocarbons with a polar solvent, such as a lower alcohol (e.g., methanol, ethanol or isopropyl alcohol) to form a washed hydrocarbon product. The more polar constituents, such as over-oxidized hydrocarbons and residual water, collect in the methanol phase, which separates from the more hydrophobic oil phase containing less oxidized hydrocarbons. It may be desirable to remove over-oxidized hydrocarbons because they are more polar and less stable than the desired liquid hydrocarbon product. If left in the hydrocarbon product, the over-oxidized hydrocarbons can continue to react, resulting in undesirable precipitates. In some cases, extraction with a polar solvent can also remove residual water from the liquid hydrocarbon product.

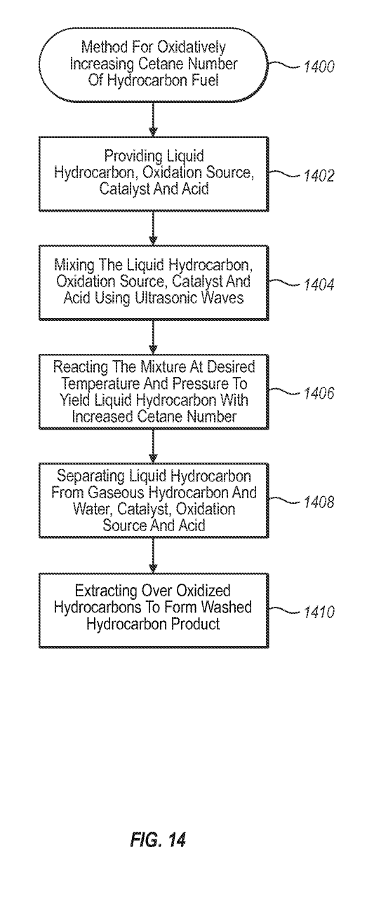

FIG. 14 is a flow chart that illustrates an exemplary method 1400 of increasing the cetane number of a liquid hydrocarbon (e.g., using the system 1200 shown in FIG. 12 and/or the ultrasonic reactor 1300 shown in FIG. 13). A first step 1402 includes providing a liquid hydrocarbon, oxidation source, catalyst and acid as described herein. A second step 1404 involves mixing the liquid hydrocarbon, oxidation source, catalyst and acid using ultrasonic waves, or ultrasonic cavitation to effect high energy mixing. This results in a third step 1406, which includes reacting the mixture at a desired temperature, pressure and time to yield a liquid hydrocarbon product having increased cetane number. A fourth step 1408 includes separating the liquid hydrocarbon from gaseous hydrocarbons and also water, catalyst, oxidation source, and acid. A fifth step 1410 includes extracting over-oxidized hydrocarbons from the liquid hydrocarbon to form a washed hydrocarbon product in the oil phase and over-oxidized hydrocarbons in the polar solvent phase. Removing the over-oxidized hydrocarbons yields a more stable end product.

FIG. 15 schematically depicts an alternative embodiment of a reaction system 1500 for increasing the cetane number of a liquid hydrocarbon. In this embodiment, an aqueous mixture 1502 comprised of water and an organic or inorganic acid is pretreated by mixing and reacting the aqueous mixture 1502 with ozone 1504 within a pretreating cavitation reactor 1506. The pretreating cavitation reactor 1506 can be any reactor that is able to cause the ozone to form reactive hydroxyl radicals and/or oxygen radicals within the pretreated aqueous mixture. Excess ozone 1508 can be removed from the top of cavitation reactor 1506 through a conduit or other venting means known in the art. One example of a cavitation reactor is an ultrasound reactor, which may be the same or similar to the ultrasound reactor described above and used in reacting the liquid hydrocarbon feedstock with the oxidation source. Other cavitation reactors can create cavitation by a spinning rotor, oscillating magnetic field, hydrodynamic flow, optic cavitation, or particle cavitation.

The pretreatment time of the aqueous mixture with ozone in the pretreatment reactor 1506 can be in a range of about 30 seconds to about 10 minutes, preferably in a range of about 45 seconds to about 8 minutes, and more preferably in a range of about 1 minute to about 5 minutes. The temperature may be room temperature (i.e., about 20-25° C.) and the pressure may be 1 bar to about 30 bars, preferably about 3 bars to about 25 bars, and more preferably about 5 bars to about 20 bars.

The pretreated aqueous mixture from pretreatment reactor 1506 and liquid hydrocarbon feedstock 1512 are introduced into upgrading reactor 1510, which includes means for mixing the liquid hydrocarbon feedstock and pretreated aqueous mixture together. At least some of the excess ozone 1508 from pretreatment reactor 1506 can also be introduced into upgrading reactor 1510. According to one embodiment, mixing may be provided at least in part by mechanical stirring. According to another embodiment, mixing may be provided at least in part by ultrasonic cavitation. A combination of mechanical mixing and ultrasonic cavitation may be provided within upgrading reactor 1510 in order to promote beneficial oxygenation reactions between hydroxyl radicals provided by the pretreated aqueous mixture and the liquid hydrocarbon. As in the embodiment described above relative to FIG. 12, a series of upgrading reactors can be included, which utilize one or both of mechanical stirring or ultrasonic cavitation. The reactants are maintained within the upgrading reactor 1510 for a time and at a temperature and pressure sufficient to carry out the desired oxygenation reaction in order to raise the cetane number of the liquid hydrocarbon product relative to the liquid hydrocarbon feedstock (e.g., see time, temperature and pressures set forth above relative to the embodiment of FIG. 1). Gases 1513 can be removed from the top of upgrading reactor 1510.

After the liquid hydrocarbon has been converted into a liquid hydrocarbon product having a higher cetane number (e.g., diesel fuel additive), the reactants are transferred from the upgrading reactor 1510 into a liquid/liquid separator 1514, which separates an upgraded hydrocarbon product 1516 from water and acid. Recycle water and acid 1518 can be introduced back into cavitation reactor 1506. Excess (or “spent”) water and acid 1520 are separated from the recycle water and acid and discarded. The hydrocarbon product 1516 can be further washed using a polar solvent (e.g., methanol) to yield a washed hydrocarbon product 1522 that is separated by phase separation from over-oxidized hydrocarbons 1524 in a polar solvent phase.

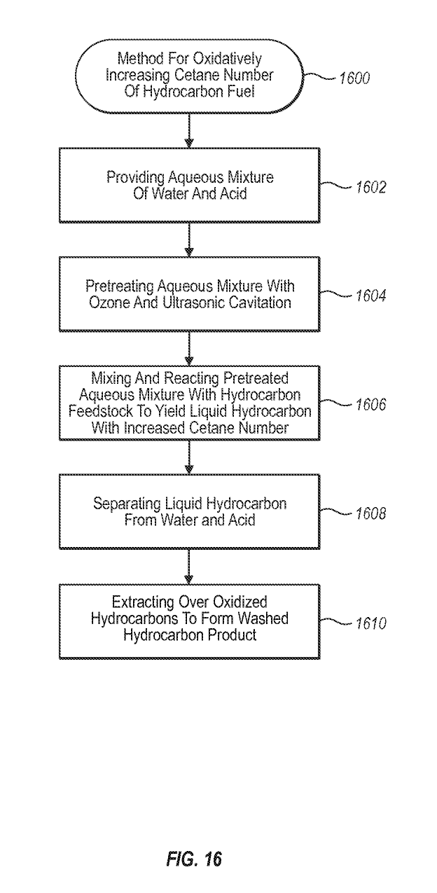

FIG. 16 is a flow chart that illustrates an exemplary method 1600 of increasing the cetane number of a liquid hydrocarbon (e.g., using the system 1500 shown in FIG. 15 and/or the ultrasonic reactor 1300 shown in FIG. 13). In a first step 1602 water, acid and ozone are provided. The water and acid are typically provided as an aqueous mixture and the ozone as a separate stream. In a second step 1604, the aqueous mixture and ozone are subjected to ultrasonic cavitation in order to form a pretreated aqueous mixture having reactive hydroxyl radicals formed therein. In a third step 1606, the pretreated aqueous mixture is mixed and reacted together with a liquid hydrocarbon feedstream in order to yield an upgraded liquid hydrocarbon having an increased cetane number. In a fourth step 1608, the upgraded liquid hydrocarbon product is separated from the water and acid. In a fifth step 1610, over-oxidized hydrocarbons are extracted from the desired product using a polar solvent (e.g., methanol) to form a washed hydrocarbon product that is more stable and less reactive.

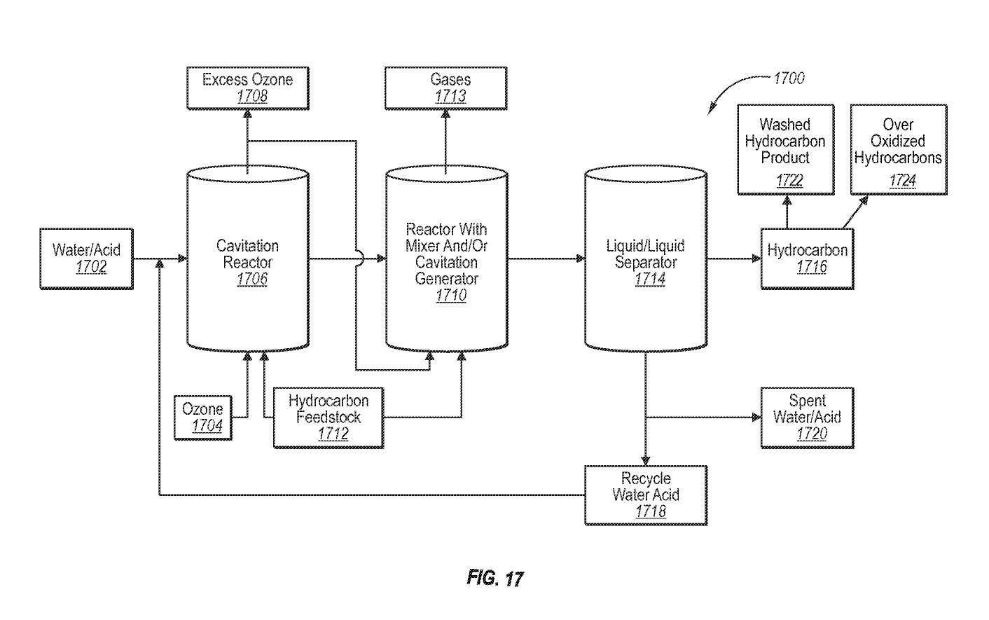

FIG. 17 schematically depicts an alternative embodiment of a reaction system 1700 for increasing the cetane number of a liquid hydrocarbon. In this embodiment, an aqueous mixture 1702 comprised of water and an organic or inorganic acid, ozone 1704, and a portion of a liquid hydrocarbon feedstock 1712 are reacted together in a first cavitation reactor 1706. The first cavitation reactor 1706 can be any reactor that is able to create cavitation, as discussed herein. Excess ozone 1708 can be removed from the top of first cavitation reactor 1706 through a conduit or other venting means known in the art.

The reactants from first cavitation reactor 1706, excess ozone 1708, and a second portion of the liquid hydrocarbon feedstock 1712 are introduced into second upgrading reactor 1710, which includes means for mixing the reactants together. According to one embodiment, mixing may be provided at least in part by mechanical stirring. According to another embodiment, mixing may be provided at least in part by cavitation, as discussed herein. A combination of mechanical mixing and ultrasonic cavitation may be provided within second upgrading reactor 1710 in order to promote beneficial oxygenation reactions of the liquid hydrocarbon. The reactants are maintained within the first cavitation reactor 1706 and second upgrading reactor 1710 for a time and at a temperature and pressure sufficient to carry out the desired oxygenation reaction in order to raise the cetane number of the liquid hydrocarbon product relative to the liquid hydrocarbon feedstock (e.g., see time, temperature and pressures set forth above relative to the embodiment of FIG. 12).

After the liquid hydrocarbon has been converted into a liquid hydrocarbon product having a higher cetane number (e.g., diesel fuel additive), the reactants are transferred from the second upgrading reactor 1710 into a liquid/liquid separator 1714, which separates an upgraded hydrocarbon product 1716 from water and acid. Recycle water and acid 1718 can be introduced back into first cavitation reactor 1706. Excess (or “spent”) water and acid 1720 are separated from the recycle water and acid and discarded. The upgraded hydrocarbon product 1716 can be washed using a polar solvent (e.g., methanol) to extract over-oxidized hydrocarbons and yield a washed hydrocarbon product 1722 that is in a separate phase from the over-oxidized hydrocarbons 1724. This waste polar fraction can be discarded as desired or it can be used as a fuel where heat is desired to drive a reaction.

The product that is produced by the foregoing systems and methods includes oxygenated hydrocarbon species. Oxygenates blended into diesel fuel can serve at least two purposes. First, they can improve cetane number compared to non-oxygenated diesel fuel. Components based on renewable feedstocks can provide the added benefit of reducing net emissions of greenhouse gases in the form of carbon dioxide emissions. Second, oxygenates blended into diesel fuel helps reduce particulate emissions and also oxides of nitrogen (NOx).

The foregoing oxidative systems and methods can yield a product that can be characterized as “super cetane diesel” as it has a cetane number that is substantially higher than 55, typically higher than about 75, preferably higher than about 100. The super cetane diesel produced by the inventive systems and process can be used as a blending stock for diesel fuels having lower cetane numbers in order to yield blended diesel fuels having a desired cetane number (e.g., diesel fuels from a hydrotreater).

By using the inventive process, the cetane number of a starting feedstock material can be increased by at least about 15%, preferably by at least about 20%, more preferably by at least about 30%, even more preferably by at least about 50%, and most preferably by at least about 75%. Such processes also result in an increase in cetane number of at least about 7.5, preferably at least about 10, more preferably at least about 15, even more preferably at least about 25, especially at least about 50, and most preferably at least about 75.

In many cases, the resulting product has a cetane number so high that it is best suited as a blending additive to raise the cetane number of a lower cetane number diesel fuel rather than as a diesel fuel by itself. According to one embodiment, the final blending stock can have a cetane number greater than about 60, preferably greater than about 75, more preferably greater than about 90, and most preferably greater than about 125.

The following examples of the invention are given by way of example only, and not by limitation. They are provided in order to illustrate particular methodologies for carrying out the invention. It will be understood that there are other ways, including other reaction conditions and reactants, which can be used to carry out the invention described herein.

For Examples 1-6, batch oxidation tests were conducted in a beaker using the following components:

Diesel—beginning cetane number=52

Acetic acid—100% purity; density=1.05 g/ml

Formic acid >98% purity; density=1.22 g/ml

Aqueous hydrogen peroxide—30% concentration; density=1.463 g/ml

Ozone—containing <1% ozone in a stream of air

Distilled water

Ultrasound device—Hielscher UP400S (400 watts, 24 kHz)

### Comparative Example 1

With reference to U.S. Pat. No. 5,114,434 (Praulus et al.), 300 ml of diesel and 30 ml of aqueous hydrogen peroxide were placed into in a 500 ml beaker and vigorously stirred for 10 minutes at 25° C. using a magnetic stirrer. The resulting diesel product was then vigorously stirred with methanol in a ratio of 1 part methanol to 1 part diesel product to extract over-oxidized reaction products. The methanol washed diesel product was injected into an IQT machine manufactured by Advanced Engine Technology. The methanol washed diesel product as prepared according to the procedure described in U.S. Pat. No. 5,114,434 had a measured cetane number of 57, which was an increase of 5 over the initial cetane number of the starting diesel material.

### Comparative Example 2

With reference to U.S. Pat. No. 6,500,219 (Gunnerman), an illustrative desulfurization system used a stainless steel ultrasound chamber having an internal volume of 3 liters, and diesel fuel and water as the fossil fuel and aqueous fluids, respectively, at three parts by volume of diesel fuel to one part by volume of water. The diesel fuel was preheated to a temperature of about 75° C.; the water was not preheated. Hydrogen peroxide was added to the water as a 3% (by weight) aqueous solution, at 0.0025 parts by volume of the solution to one part by volume of the water. A surface active agent (extra heavy mineral oil) was added to the diesel at approximately 0.001 part by volume of the mineral oil to one part by volume of the diesel. The entire mixture was passed into the ultrasound reactor at a flow rate of approximately 1 gallon per minute (3.8 liters/min) at approximately atmospheric pressure. The ultrasound chamber contained a stainless steel screen on which rested approximately 25 grams each of silver and nickel pellets, each approximately one-eighth inch (0.3 cm) in diameter).

Ultrasound was supplied to the ultrasound chamber by an ultrasound probe suspended from above with its lower end terminating approximately 5 cm above the metal pellets. Ultrasound was supplied to the probe by an ultrasound generator as follows: Ultrasound generator: Supplier: Sonics & Materials, Inc., Newtown, Conn., USA Power supply: net power output of 800 watts (run at 50%) Voltage: 120 V, single phase Current: 10 amps Frequency: 20 kHz.

The two-phase mixture emerging from the ultrasound chamber passed through two cloth filters into a separation chamber, from the top of which desulfurized diesel was drawn, while from the bottom of which the aqueous phase were drawn. Substantially all of the original sulfur-bearing molecules in the diesel feed were removed in the aqueous phase. The overall yield of diesel was reduced by the amount of oxidized sulfur-bearing molecules that were removed in the aqueous phase.

### Example 3

An aqueous solution comprised of 50 ml of acetic acid and 150 ml of distilled water was placed into a 500 ml beaker. A Hielscher UP400S ultrasound device was inserted into the beaker. Thereafter a stream of ozone-containing air was bubbled into the aqueous solution while the ultrasound device was turned on at 100% amplitude for 5 minutes. The resulting ozone-treated aqueous solution and 200 ml of diesel initially at a temperature of about 30° C. were vigorously stirred for 10 minutes using a magnetic stirrer, with a reaction temperature of about 30-60° C. The resulting diesel product was then vigorously stirred with methanol (in a ratio of 1 part methanol to 1 part diesel) to extract over-oxidized reaction products. The methanol washed diesel product was injected into an IQT machine and determined to have a measured cetane number of 60.4, which was an increase of 8.4 over the initial cetane number of the starting diesel material.

### Example 4

An aqueous solution consisting of 5 ml formic acid, 25 ml aqueous hydrogen peroxide, and 70 ml distilled water was placed into a 500 ml beaker together with 300 ml of diesel at a temperature of about 30° C. A Hielscher UP400S ultrasound device was inserted into the beaker. Thereafter a stream of ozone-containing air was bubbled through the aqueous and diesel phases while the ultrasound device was turned on at 100% amplitude for 5 minutes. The reaction was maintained at a temperature of about 30-60° C. A very thick emulsion was formed at the end of test. The emulsion broke within 60 minutes. The resulting diesel product was washed with methanol as in Example 1 and 2 to extract over-oxidized reaction products. The methanol washed diesel product was injected into an IQT machine and determined to have a measured cetane number of 61, which was an increase of 9 over the initial cetane number of the starting diesel material.

### Example 5

An aqueous solution consisting of 5 ml formic acid, 25 ml aqueous hydrogen peroxide was placed into a 500 ml beaker together with 300 ml of diesel at a temperature of about 30° C. A Hielscher UP400S ultrasound device was inserted into the beaker. Thereafter a stream of ozone-containing air was bubbled through the aqueous and diesel phases while the ultrasound device was pulsed at a mode of 0.3 and 40% amplitude for 10 minutes. The reaction was maintained at a temperature of about 30-60° C. An emulsion was observed to form instantaneously, but which also broke rapidly. The resulting diesel product was washed with methanol to extract over-oxidized reaction products. The methanol washed diesel product was injected into an IQT machine and determined to have a measured cetane number of 62.0, which was an increase of 10 over the initial cetane number of the starting diesel material.

### Example 6

An aqueous solution consisting of 5 ml formic acid, 25 ml aqueous hydrogen peroxide, and 70 ml distilled water was placed into a 500 ml beaker together with 300 ml of diesel at a temperature of about 30° C. A Hielscher UP400S ultrasound device was inserted into the beaker and the mixture was subjected to ultrasound at 100% amplitude for 10 minutes. The reaction was maintained at a temperature of about 30-60° C. A very thick emulsion was formed at the end of test. The emulsion broke within 60 minutes. The resulting diesel product was washed with methanol as in previous examples to separate it from over-oxidized reaction products. The methanol washed diesel product was injected into an IQT machine and determined to have a measured cetane number of 64.2, which was an increase of 12.2 over the initial cetane number of the starting diesel material.

### Example 7

An aqueous solution consisting of 5 ml formic acid and 5 ml of aqueous hydrogen peroxide was placed into a 500 ml beaker together with 300 ml of diesel at a temperature of about 30° C. A Hielscher UP400S ultrasound device was inserted into the beaker and the mixture was subjected to ultrasound at 100% amplitude for 10 minutes while ozone containing air was continuously bubbled into the aqueous solution. The reaction was maintained at a temperature of about 30-60° C. An emulsion formed, which broke within 30 minutes after the test. The resulting diesel product was washed with methanol as in previous examples. The methanol washed diesel product was injected into an IQT machine and determined to have a cetane number of 62.4, which was an increase of 10.4 over the initial cetane number of the starting diesel material.

For comparison purposes, the conditions and results of Examples 1-6 are set forth in Table 1 below:

TABLE 1

| Example | 1 | 2 | 3 | 4 | 5 | 6 |
|---|---|---|---|---|---|---|
| Acid-acetic (A) or | | 50 ml-(A) | 5 ml-(F) | 5 ml-(F) | 5 ml-(F) | 5 ml-(F) |
| formic (F) | | | | | | |
| Hydrogen peroxide, ml | 30 | | 25 | 25 | 25 | 5 |
| Distilled water, ml | | 150 | 70 | | 70 | |
| Ozone | | Yes | Yes | Yes | None | Yes |
| Ultrasound intensity | | Maximum | Maximum | 40% at 0.3 | Maximum | Maximum |
| Time, minute | 10 | 5 | 5 | 10 | 10 | 10 |
| Magnetic stirrer | yes | Yes | | | | |
| Diesel, ml | 300 | 300 | 300 | 300 | 300 | 300 |
| Measured cetane | 57.8 | 60.4 | 61 | 62 | 64.2 | 62.4 |
| number | | | | | | |
| Change in cetane | 5.8 | 8.4 | 9 | 10 | 12.2 | 10.4 |
| number compared to | | | | | | |
| original diesel | | | | | | |
| Percentage change in | 11.2% | 16.2% | 17.3% | 19.2% | 23.5% | 20% |
| cetane number | | | | | | |
| compared to original | | | | | | |
| diesel | | | | | | |

As seen in Table 1, all test conditions that were run according to the present invention (Examples 2 to 6) show a significantly higher increase in cetane number compared to the test that was run according to Comparative Example 1. Introducing ultrasound into the reaction vessel, even for just 5 minutes, significantly increased the cetane number over Comparative Example 1, which is a surprising and unexpected result. In continuous flow tests and at optimum conditions, the inventors expect much higher cetane numbers using the inventive process.

In addition, substantially less oxidation of sulfur-bearing molecules occurred than according to Comparative Example 2, which greatly increased the yield of higher cetane product compared to the process of Comparative Example 2.

### Examples 8-14

Any of the foregoing oxidative processes is combined with a hydrotreating process to yield an upgraded liquid fuel product having increased cetane number and reduced sulfur content. Combining hydrotreating with oxidative treatment increases yield and product quality compared to yield and quality of product produced only from either a hydrotreatment and or oxidative treatment process by itself, regardless of reaction conditions. In addition, the process for oxidative treatment can be operated at harsher conditions (e.g., higher temperature and/or pressure) to improve yield and/or reduce reaction time when using a low-sulfur containing material, such as the hydrotreated/hydrodesulfurized material produced by the hydrotreating process, without producing excessive quantities of water-soluble byproducts as deliberately occurs when using the desulfurization process of Comparative Example 2.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for combined reductive and oxidative treatment of a liquid hydrocarbon feedstock to form an upgraded liquid fuel having increased cetane number and reduced sulfur content, comprising:
providing a liquid hydrocarbon feedstock having an initial cetane number and an initial sulfur content;
reductively hydrotreating a first liquid feedstream selected from (1) at least a portion of the liquid hydrocarbon feedstock and (2) at least a portion of a partially upgraded feedstream formed by oxidative treatment of at least a portion of the liquid hydrocarbon feedstock;
oxidatively treating a second liquid feedstream selected from (1) at least a portion of the liquid hydrocarbon feedstock and (2) at least a portion of a partially upgraded feedstream formed by reductive hydrotreatment of at least a portion of the liquid hydrocarbon feedstock; and
collecting the upgraded liquid fuel produced by the combined reductive and oxidative treatment of the liquid hydrocarbon feedstock, the upgraded liquid fuel having a higher cetane number and a lower sulfur content than the liquid hydrocarbon feedstock.

2. A method as in claim 1, wherein reductively hydrotreating a first liquid feedstream comprises hydrotreating all of the liquid hydrocarbon feedstock to form a hydrotreated hydrocarbon intermediate, and wherein oxidatively treating a second liquid feedstream comprises oxidatively treating at least a portion of the hydrotreated hydrocarbon intermediate.

3. A method as in claim 2, further comprising dividing the liquid hydrotreated hydrocarbon intermediate into a first hydrotreated intermediate stream and a second hydrotreated intermediate stream, wherein oxidatively treating a second liquid feedstream comprises oxidatively treating the first hydrotreated intermediate stream to yield a high cetane number blending stock, and wherein collecting the upgraded liquid fuel comprises blending the high cetane number blending stock with the second hydrotreated intermediate stream.

4. A method as in claim 2, wherein oxidatively treating a second liquid feedstream comprises oxidatively treating all of the liquid hydrotreated hydrocarbon intermediate.

5. A method as in claim 1, wherein oxidatively treating a second liquid feedstream comprises oxidatively treating all of the liquid hydrocarbon feedstock to form a liquid oxidatively treated hydrocarbon intermediate, and wherein reductively hydrotreating a first liquid feedstream comprises hydrotreating at least a portion of the liquid oxidatively treated hydrocarbon intermediate.

6. A method as in claim 1, further comprising dividing the liquid hydrocarbon feedstock into a first feedstock stream and a second feedstock stream, wherein reductively hydrotreating a first liquid feedstream comprises hydrotreating all of the first feedstock stream to yield a hydrotreated intermediate stream, wherein oxidatively treating a second liquid feedstream comprises oxidatively treating all of the second feedstock stream to yield a high cetane number blending stock, and wherein collecting the upgraded liquid fuel comprises blending the hydrotreated intermediate stream with the high cetane number blending stock.

7. A method as in claim 1, wherein reductively hydrotreating a first liquid feedstream comprises passing the first liquid feedstream through a fixed bed hydrotreating reactor comprising a solid heterogeneous hydrotreating catalyst and hydrogen in order to remove at least a portion of the sulfur in the first liquid feedstream as hydrogen sulfide.

8. A method as in claim 7, wherein the fixed bed hydrotreating reactor further removes at least one of nitrogen, oxygen, halides, or metals from the first liquid feedstream and/or hydrogenates unsaturated carbon-carbon bonds in the first liquid feedstream and saturates olefins and/or converts aromatic compounds to paraffin compounds.

9. A method as in claim 7, wherein the solid heterogeneous hydrotreating catalyst comprises a support and at least one catalytic metal on the support selected from molybdenum, cobalt, nickel, tungsten, vanadium, iron, and combinations thereof.

10. A method as in claim 1, wherein oxidatively treating a second liquid feedstream comprises mixing the second liquid feedstream with an oxidation source.

11. A method as in claim 10, wherein mixing the second liquid feedstream with an oxidation source comprises:
introducing the second liquid feedstock into a cavitation reactor together with an oxidation source, acid, and optionally a catalyst; and
mixing together and promoting cetane-increasing reactions involving hydrocarbons in the liquid hydrocarbon feedstock, the oxidation source, and the optional catalyst in the cavitation reactor to yield an oxygenated hydrocarbon product having a cetane number that is at least about 15% higher than the initial cetane number of the liquid hydrocarbon feedstock.

12. A method as defined in claim 11, wherein oxidatively treating a second liquid feedstream comprises utilizing a plurality of cavitation reactors in series.

13. A method as defined in claim 11, wherein:
the oxidation source comprises at least one of aqueous hydrogen peroxide,
organic peroxides, inorganic peroxides, or ozone;
the acid comprises at least one of organic acid, acetic acid, formic acid, oxalic acid, benzoic acid, inorganic acid, sulfuric acid, nitric acid, or hydrochloric acid;
the catalyst being included and comprising at least one metal selected from the group consisting of iron, nickel, vanadium, and molybdenum; and
cavitation is provided by at least one of ultrasonic cavitation, a spinning rotor, an oscillating magnetic field, hydrodynamic flow of liquid reactants within the cavitation reactor, optic cavitation, or particle cavitation.

14. A method as in claim 11, wherein mixing the second liquid feedstream with an oxidation source comprises:
introducing an oxidation source and an aqueous mixture comprised of water and acid into an ultrasonic cavitation reactor;
subjecting the aqueous mixture and oxidation source to ultrasonic cavitation to yield a pretreated aqueous mixture having hydroxyl radicals;
mixing the pretreated aqueous mixture with the second liquid feedstream and optionally a catalyst to yield an oxygenated hydrocarbon product having a cetane number that is at least about 20% higher than the initial cetane number of the liquid hydrocarbon feedstock

15. A method as defined in claim 1, the liquid hydrocarbon feedstock comprising at least one material selected from the group consisting of hydrocarbons, having a boiling point in a range of about 150° C. to about 380° C., refinery streams, straight petroleum runs, thermally cracked hydrocarbons, catalytically cracked hydrocarbons, hydrocracked hydrocarbons, biodiesels, vegetable oils, animal fats, and a material produced by visbreaking at least one of bright stock, used lubricating oil, and gas oil with a boiling point in a range of about 200° C. to about 500° C.

16. A method as defined in claim 1, further comprising:
separating a liquid hydrotreated fraction from a gaseous fraction following reductively hydrotreating a first liquid feedstream; and
separating a liquid oxidatively treated product from light hydrocarbon gases, water, catalyst, and oxidation source by means of phase separation following oxidatively treating a second liquid feedstream.

17. A method as defined in claim 1, wherein the upgraded liquid fuel has a cetane number that is at least about 15% higher than the initial cetane number of the liquid hydrocarbon feedstock and a sulfur content that is reduced by at least about 50% compared to the initial sulfur content of the liquid hydrocarbon feedstock.

18. A method as defined in claim 3, wherein the high cetane number blending stock has a cetane number that is at least about 30% higher than the initial cetane number of the liquid hydrocarbon feedstock, and wherein the combined reductive and oxidative treatment of the liquid hydrocarbon feedstock produces at least about 10% more upgraded liquid fuel compared to a process in which the liquid hydrocarbon feedstock is only oxidatively treated in the absence of hydrotreating to yield a liquid fuel having the same cetane number as the upgraded liquid fuel.

19. A method for combined reductive and oxidative treatment of a liquid hydrocarbon feedstock to form an upgraded liquid fuel having increased cetane number and reduced sulfur content, comprising:
providing a liquid hydrocarbon feedstock having an initial cetane number and an initial sulfur content;
reductively hydrotreating the liquid hydrocarbon feedstock to yield a liquid hydrotreated hydrocarbon intermediate;
dividing the liquid hydrotreated hydrocarbon intermediate into a first hydrotreated intermediate stream and a second hydrotreated intermediate stream;
oxidatively treating the first hydrotreated intermediate stream to yield a high cetane number blending stock; and
combining the high cetane number blending stock with the second hydrotreated intermediate stream to yield the upgraded liquid fuel, the upgraded liquid fuel having a higher cetane number and a lower sulfur content than the liquid hydrocarbon feedstock.

20. A method as defined in claim 19, the upgraded liquid fuel having a cetane number at least about 25% higher than the initial cetane number of the liquid hydrocarbon feedstock and a sulfur content that is less than about 75% of the initial sulfur content of the liquid hydrocarbon feedstock.

21. A method as defined in claim 19, wherein the method produces a high cetane number blending stock having a cetane number that is at least about 30% higher than the initial cetane number of the liquid hydrocarbon feedstock.

22. A method as defined in claim 19, wherein the combined reductive and oxidative treatment of the liquid hydrocarbon feedstock produces at least about 15% more upgraded liquid fuel compared to a process in which the liquid hydrocarbon feedstock is only oxidatively treated in the absence of hydrotreating to yield a liquid fuel having the same cetane number as the upgraded liquid fuel.

23. A method for combined reductive and oxidative treatment of a liquid hydrocarbon feedstock to form an upgraded liquid fuel having increased cetane number and reduced sulfur content, comprising:
providing a liquid hydrocarbon feedstock having an initial cetane number and an initial sulfur content, the liquid hydrocarbon feedstock comprising at least one material selected from the group consisting of hydrocarbons, having a boiling point in a range of about 150° C. to about 380° C., refinery streams, straight petroleum runs, thermally cracked hydrocarbons, catalytically cracked hydrocarbons, hydrocracked hydrocarbons, biodiesels, vegetable oils, animal fats, and a material produced by visbreaking at least one of bright stock, used lubricating oil, and gas oil with a boiling point in a range of about 200° C. to about 500° C.;
processing the liquid hydrocarbon feedstock in a hydrotreatment system to yield a liquid hydrotreated hydrocarbon intermediate having a sulfur content less than about 75% of the initial sulfur content of the liquid hydrocarbon feedstock;
dividing the liquid hydrotreated hydrocarbon intermediate into a first hydrotreated intermediate stream and a second hydrotreated intermediate stream;
oxidatively treating the first hydrotreated intermediate stream using one or more ultrasonic cativation reactors to yield a high cetane number blending stock having a cetane number that is at least about 30% greater than the initial cetane number of the liquid hydrocarbon feedstock; and
combining the high cetane number blending stock with the second hydrotreated intermediate stream to yield the upgraded liquid fuel, the upgraded liquid fuel having a cetane number that is at least about 10% greater than the initial cetane number of the liquid hydrocarbon feedstock.
